(19) United States
(12) Patent Application Publication
(10) Pub. No.: US 2004/0000112 A1
(43) Pub. Date: Jan. 1, 2004

(54) Blanket heat insulation with facing radiant barrier

(76) Inventor: Robert J. Alderman, Canyon Lake, TX (US)

Correspondence Address: George M. Thomas, Thomas, Kayden, Horstemeyer & Risley, #1750, 100 Galleria Parkway, N.W., Atlanta, GA, 30339-5948, US

(21) Appl. No.: 10/186,454

(22) Filed: Jun. 28, 2002

(51) Int. Cl. E04B 1/74; B32B 3/14; E04B 1/00

(52) U.S. Cl. 52/407.3; 52/741.1; 428/77; 428/172

(57) ABSTRACT

The blanket heat insulation with facing radiant barrier includes a heat insulation blanket assembly (10) that is to be placed in a wall structure of a building. The heat insulation blanket assembly includes a blanket formed of fibrous materials such as fiberglass, with the fibers being arranged in random array and defining air gaps therebetween for insulation purposes. Flexible sheet (26) is positioned in superposed relationship with respect to a broad surface of the blanket (12), and includes a reflective surface (42) that faces the blanket. The fibers of the blanket engage and support the flexible sheet without requiring an adhesive or other connection therebetween. This leaves the air gaps between the fibers of the blanket exposed to the heat reflective surface of the flexible sheet material, so that the air gaps tend to maintain the reflective properties of the reflective surface of the flexible sheet material.

### FIELD OF THE INVENTION

This invention relates generally to heat insulation devices for building structures. More specifically, the present invention relates to a heat insulation blanket assembly which includes a blanket of heat insulation material and a radiant barrier adjacent the blanket material for retarding the transfer of radiant heat.

### BACKGROUND OF THE INVENTION

Heat insulation for building structures, used in attics, walls, floors, etc., typically comprises loose material that can be blown into place, particularly in attics, or blanket material that can be manually placed between parallel studs, joists, etc. Generally, the insulation material forms a network of air pockets or gaps which retard the transfer of heat by convection and conduction. The blanket material can comprise fiberglass, cellulose, mineral wool, and other particulate material that traps a multitude of air gaps or spaces between the fibers.

In addition to using the fibrous heat insulation material for convection and conduction insulation, it is also possible to use a heat reflective material to function as a radiant heat barrier. The radiant heat barrier can be used alone or in combination with the conduction and convection heat insulation. The radiant heat barrier can comprise a sheet of foil that has heat reflective surfaces on one or both sides. The foil sheet can be attached to convection and conduction heat insulation for providing added radiant energy reflective properties, thus adding to the total insulating value of the insulation assembly. Typically, the assembly would be placed between parallel joists, studs, etc. of an outside wall of a building structure However, it has been found that when the reflective foil sheet makes contact with an adjacent surface, the foil loses its heat reflective properties in the area where contacted.

Because of this characteristic, the tendency for providing a heat reflective insulation sheet is to make sure that the sheet does not contact adjacent structures. For example, my U.S. Pat. No. 5,918,436 discloses an insulating facing material having multiple sheets of foil of different areas attached together at their edges so that when suspended between parallel joists, etc., the lower sheet sags due to gravity a distance away from an upper sheet, creating an air gap between the sheets. This air gap functions as insulation from convection and conduction heat transfer, but also protects the radiant barrier provided by the foil from contact with other objects, thereby maintaining the heat reflective properties. Additionally, the enclosed space formed by the two overlying sheets prevents the invasion of dust, stray fibers, grit, sawdust, and other materials that might otherwise make contact with the reflective surface and reduce the reflective capability of the surface.

While the radiant barrier concept as disclosed in my Pat. No. 5,918,436 is effective and efficient, there is a need to provide an effective radiant barrier in combination with blanket insulation with the radiant barrier being able to make contact with the blanket insulation without losing the majority of its heat reflective properties. This would avoid having to maintain a space between the heat reflective sheet and the next adjacent structure.

It is to this endeavor that this invention is directed.

### SUMMARY OF THE INVENTION

Briefly described, the present invention comprises an insulating device which limits not only heat of convection and conduction, but also heat of radiation, to reduce and retard heat transfer between adjacent spaces. Typically, the insulating device would be used in building structures between spaces of different temperatures, such as in exterior walls, floors and ceilings, to retard the transfer of heat between these spaces.

More specifically, the present invention relates to a heat insulation blanket assembly that includes an elongated blanket of fibrous material, or at least having one side formed of fibrous material. The blanket typically will be of rectangular cross section with opposed flat surfaces and opposed side surfaces joining the opposed flat surfaces. Flexible sheet material is placed in superposed relationship with respect to at least one of the opposed flat surfaces bearing a fibrous surface. The flexible sheet material bears a heat reflective surface facing the fibrous surface of the blanket. The fibrous surface of the blanket has surface fibers that engage the heat reflective surface of the flexible sheet, so that the engaging fibers support the reflective sheet. The engaging fibers are spaced apart sufficiently so as to provide air gaps between themselves, with the air gaps being placed immediately adjacent the heat reflective surface of the flexible sheet. The fibers that engage the reflective surface tend to diminish the reflective properties of the flexible sheet; however, the air gaps that are formed throughout the interstices of the surface fibers and the reflective surface continue to provide unobstructed small spaces adjacent the reflective surface, thereby preserving the reflective qualities of the reflective surface.

In general, the multitude of surface fibers that support the reflective surface of the flexible sheet are formed in a random array but with a substantially uniform array of air gaps formed therebetween at the surface of the reflective sheet material, so that the reflectivity is substantially uniform across the breadth of the reflective sheet material.

Inasmuch as the reflective surface of the flexible sheet material faces the blanket, the reflective surface is protected from outside sources of dust, grime, dirt, and other items that might accumulate on the flexible sheet material during manufacture, storage, installation and use of the heat insulation blanket assembly. This tends to assure that the reflective capability of the reflective surface will not be diminished from these sources during its life of use.

In the embodiment disclosed herein, the reflective flexible sheet material is extended about one of its broad surfaces that bears a fibrous face and the opposed side surfaces, and a second layer of Kraft paper is extended about the opposed broad surface. The Kraft paper is adhesively bonded to the facing surface of the blanket. The side edges of the Kraft paper extend beyond the sides of the blanket, and the edges of the flexible sheet material are bonded to the edges of the Kraft paper. This completely surrounds the cross sectional shape of the blanket, thereby reducing the likelihood of the introduction of foreign objects, such as dirt, grime, dust, moisture, etc. to the interior blanket. The improved heat insulation blanket assembly is installed in the exterior walls, ceilings, etc. of the building structure.

Thus, it is an object of this invention is to provide a heat insulation blanket assembly that includes a blanket having a fibrous surface, and a heat reflective flexible sheet, such as foil, that is applied to the fibrous surface, so that the surface fibers of the fibrous surface engage and support the flexible sheet and provide a network of air gaps adjacent the reflective surface of the flexible sheet so as to preserve the reflective capabilities of the reflective surface.

Another object of this invention is to provide an improved method of insulating a building structure, for retarding convection, conduction and radiant heat transfer between spaces in and about the building structure, whereby the reflective surface of a flexible sheet can be placed in contact with a fibrous surface of an adjacent heat insulation blanket and maintain a substantial portion of its heat reflective capability.

Another object of the invention is to provide an inexpensive, durable, and easy to install blanket insulation assembly for building structures.

Another object of the invention is to provide improved heat insulation that provides conduction, convection and radiant heat insulation.

Another object of the invention is to provide a structure having improved convection, conduction and radiant heat insulation that is expedient to install and durable.

Other objects, features and advantages of the present invention will become apparent upon reading the following specification, when taken in conjunction with the accompanying drawings.

### BRIEF DESCRIPTION OF THE DRAWINGS

FIG. 1 is a cross-sectional isometric view of a heat insulation blanket assembly for a building structure that is to be used for retarding the transfer of heat between adjacent spaces of the building structure.

FIG. 2 is a detailed illustration of the fibrous blanket and the flexible sheet applied to a surface of the fibrous blanket.

FIG. 3 is a cross-sectional, isometric view of a heat insulation blanket assembly, similar to FIG. 1, but showing the heat reflective surface applied to a sheet insert.

FIG. 4 is a detailed illustration of the heat insulation blanket assembly of FIG. 3.

FIG. 5 is a schematic illustration of how the flexible reflective sheet material and the Kraft paper are applied to the fibrous blanket.

FIG. 6 is a cross-sectional view of a typical wall structure that embodies the invention.

### DETAILED DESCRIPTION

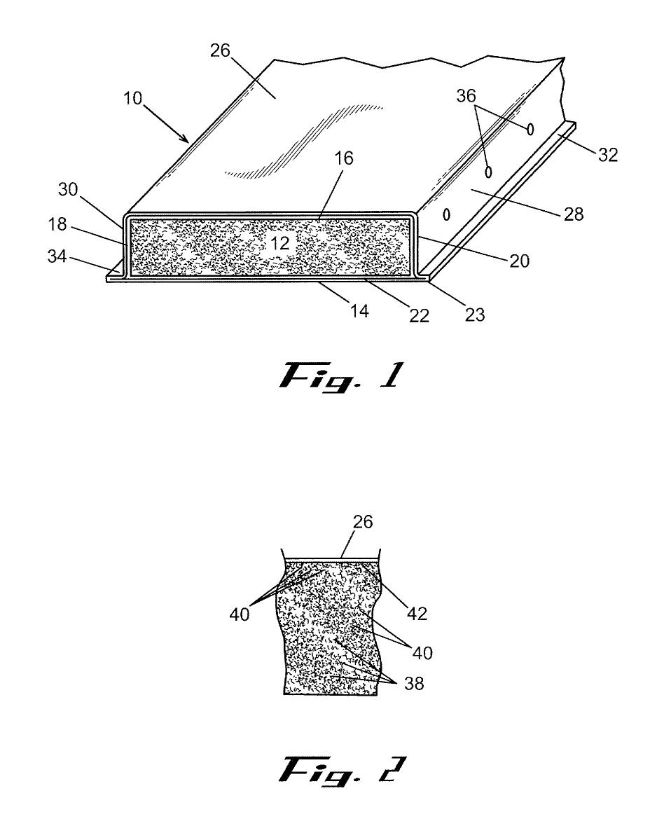

Referring now in more detail to the drawings, in which like numerals indicate like parts throughout the several views, FIG. 1 shows a heat insulation blanket assembly 10 that includes an elongated blanket of fibrous material 12 that is rectangular in cross-section. The blanket has first and second opposed broad surfaces 14 and 16, and side surfaces 18 and 20 that join the opposed broad surfaces.

A layer of Kraft paper 22 extends along the length of the blanket in superposed relationship with the first broad surface 14. The Kraft paper is bonded to the facing first broad surface 14, and clings thereto. The side edge portions 23 and 24 of the Kraft paper extend beyond the breadth of the blanket 12.

Flexible sheet 26 also extends along the length of the blanket in superposed relationship with the second broad surface 16, with its side portions 28 and 30 turned about the side surfaces 18 and 20 of the blanket. The side edges 32 and 34 of the flexible sheet 26 are turned outwardly and are superposed the side edge portions 23 and 24 of the Kraft paper, and are adhered thereto. Thus, the flexible sheet 26 and the Kraft paper 22 surround the cross-sectional shape of the blanket 12, and protect the blanket from accumulation of dust, debris, grime, moisture, etc. from an outside source.

In order to make sure that the blanket 12 reaches its full dimensions after having been stored or packed, and therefore compressed, air openings 36 are formed in the side portions 28 and 30, allowing air to be expelled from or to be induced into the enclosure formed by the layer of Kraft paper 22 and the flexible sheet 26.

As illustrated in FIG. 2, the insulation blanket 12 is formed from a mass of fibers. For example, the fibers can be fiberglass, mineral wool, or cellulose, which comprise randomly oriented fibers. The principle of using the fibrous material as the blanket is to form air gaps or pockets of air throughout the blanket. For example, the fibers 38 are randomly oriented throughout the blanket, and air gaps 40 are formed between the fibers.

The flexible sheet 26 bears a reflective surface that faces the blanket 12. The flexible sheet can be formed of aluminum foil or other metal foils, metalized polyester or metalized polyethylene. The flexible sheet has its reflective surface facing the blanket 12. This causes the reflective surface to be enclosed within the confines of the layer of Kraft paper 22 and the flexible sheet 26.

A feature of the invention is the location of the air gaps 40 adjacent the reflective surface 42. The surface fibers at the facing surface of the blanket engage and support the flexible sheet 26 without requiring an adjacent bonding surface, such as adhesive, paint, or other material or mechanical means that would cling between the flexible sheet and the blanket 12. This leaves the air gaps 40 open about the fibers 38, so that a lattice or array of air gaps are maintained immediately adjacent the reflective surface 42 of the flexible sheet 26. While the fibers 38 tend to occlude or block the reflective capability of the reflective surface of the flexible sheet 26, the adjacent air gaps tend to maintain the reflectivity of the reflective surface of the flexible sheet.

The area of contact of the air gaps 40 against the reflective surface 42 of the flexible sheet 26 is estimated to be at least five times greater than the area of contact of the fibers 38 against the flexible sheet. Thus, in spite of the use of the fibers to support the flexible sheet, and in spite of the contact made by the fibers against the flexible sheet, it is estimated that over 80% of the heat reflective capability of the reflective surface of the flexible sheet is maintained in this configuration.

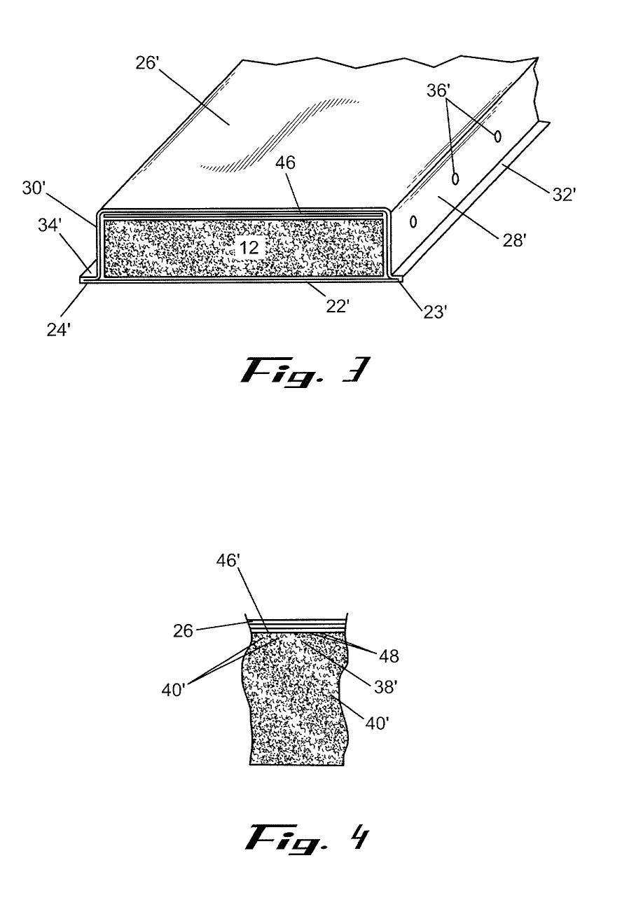

FIGS. 3 and 4 show a second embodiment of the invention, whereby an additional sheet 46 is placed between the blanket 12′ and the flexible sheet 26′. In this embodiment, the flexible sheet 26′ does not have to be formed with a heat reflective surface. The additional sheet 46 has a heat reflective surface that faces the blanket 12′. The other elements of the embodiment of FIG. 3 are similar to those of FIG. 1, such as the Kraft paper 22′, side edge portions 23′ and 24′, the side portions 28′ and 30′ of the flexible sheet 26′, the side edges 32′ and 34′, and the air openings 36′. Thus, the embodiment of FIG. 3 can utilize separate materials for forming the flexible sheet 26′ and the reflective sheet 46. For example, the reflective sheet 46 can be made of very thin aluminum foil while the flexible sheet 26 can be made of a more protective material, such as polyester or polyethylene.

FIG. 4 shows that the principle of operation of the embodiment of FIGS. 3 and 4 is the same, in that air gaps 40′ are formed about the fibers 38′ at the reflective surface 48 of the reflective sheet 46.

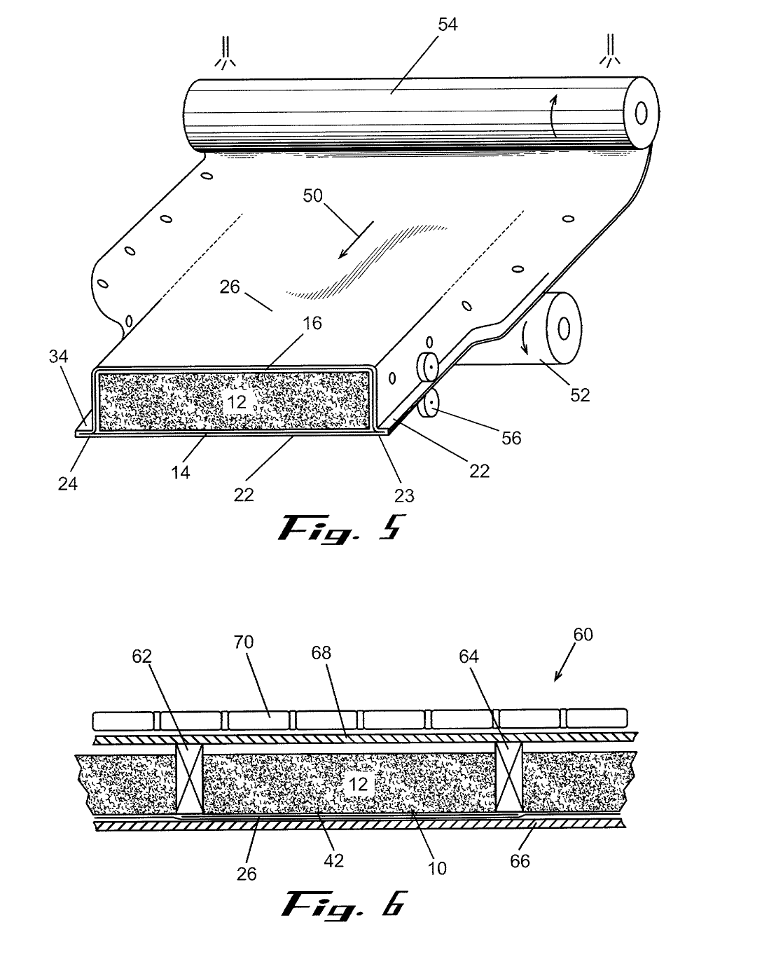

FIG. 5 is a schematic illustration of the process of forming the heat insulation blanket assembly of FIGS. 1 and 2. A continuous length of blanket material 12 is advanced along its length in the direction indicated by arrow 50, and as it is advanced, Kraft paper 22 is paid out from a supply 52 and moved in the same direction. The Kraft paper is coated with adhesive and the adhesive bonds the Kraft paper to the first broad surface 14 of the blanket 12. In the meantime, the flexible sheet 26 is advanced from its supply in the same direction and is formed in an inverted U-shape about the blanket 12. The edges 23, 32 and 24, 34 are formed in overlying relationship and are bonded together by heat fusing, adhesive, or other conventional means schematically indicated at 56.

In the situation where the embodiment of FIG. 3 is to be formed, the supply 54 of the flexible sheet is preformed with the additional reflective sheet 46 (not shown in FIG. 5) so as to be applied to the facing second broad surface 16 of the blanket 12.

As illustrated in FIG. 6, the heat insulation blanket assembly 10 is installed in a conventional wall structure 60 which includes upright parallel studs 62 and 64, the heat insulation blanket assembly 10 positioned between the studs with the side portions forming connector flanges that are easily attached to a surface of the studs by staples, nails, adhesive, etc. Gypsum board 66 is applied in the conventional manner to the studs 62 and 64 on the interior of the wall structure, and ply board or other rigid sheet material 68 is applied to the opposed surfaces of the studs, to face the exterior of the building structure. A facade such as brick 70, clapboard, stucco, or other conventional building materials typically will be applied to the external sheet 68.

In the embodiment shown in FIG. 6, the heat reflective surface 42 of the flexible sheet 26 is positioned between the blanket 12 and the interior of the building structure. However, the heat insulation blanket assembly 10 can be reversed in the wall structure so as to place the flexible sheet 26 and its reflective surface 42 between the blanket 12 and the exterior of the building.

The drawings show the reflective sheet positioned in abutment with the fibers of the blanket; however, if the heat insulation blanket assembly is oriented with the reflective sheet below the blanket, the reflective sheet is likely to sag away from the blanket due to the influence of gravity, When this happens, the reflective sheet is likely to have less of its surface occluded by the fibrous material and therefore be even more reflective.

While the invention has been disclosed with the blanket 12 formed of fibrous materials, such as fiberglass, the blanket can be formed of other materials, and the surface facing the flexible sheet and its heat reflective surface can be made of fibrous materials, so that a mass of surface fibers is positioned at the position that contacts the reflective surface, so as to provide the desired air gaps at the reflective surface.

Although preferred embodiments of the invention have been disclosed in detail herein, it will be obvious to those skilled in the art that variations and modifications of the disclosed embodiments can be made without departing from the spirit and scope of the invention as set forth in the following claims.

I claim:

1. A heat insulation blanket assembly for a building structure for retarding the transfer of heat between spaces in and about the building structure, comprising:
an elongated blanket of fibrous material of substantially rectangular cross section having first and second opposed flat surfaces and opposed side surfaces joining said opposed flat surfaces,
a layer of Kraft paper extending along the length of said blanket superposed said first surface and adhesively bonded to said first surface,
flexible sheet material extending along the length of said blanket superposed said second surface, said sheet material bearing a metalized heat reflective surface facing said second surface of said fibrous blanket,
said fibrous blanket having surface fibers positioned at said second surface for engaging said metalized surface of said sheet material with air gaps formed about said surfaces fibers,
whereby said surface fibers of said second surface of said blanket can support said sheet material with the air gaps between said surface fibers maintaining the reflectivity of said of said reflective surface of said sheet material about said surface fibers.

2. The heat insulation blanket assembly of claim 1, wherein said sheet material surrounds said second surface and said opposed side surfaces of said blanket and is bonded to said Kraft paper.

3. The heat insulation blanket of claim 1, wherein said blanket is formed of material selected from the group consisting of fiberglass, mineral wool, and cellulose.

4. The heat insulation blanket assembly of claim 1, wherein said sheet material is selected from the group consisting of: polyester having a metal surface, polyethylene with a metalized surface, and aluminum.

5. The heat insulation blanket assembly of claim 1, wherein said air gaps between said surface fibers engage more area of said sheet material than said surface fibers.

6. The heat insulation blanket assembly of claim 1, wherein said sheet material has a series of spaced air openings formed therein for the passage of air into and out of said blanket.

7. The heat insulation blanket assembly of claim 1, wherein said layer of Kraft paper extends beyond the sides of said blanket and forms mounting strips along said sides of said blanket for mounting said heat insulation blanket to adjacent structures.

8. The heat insulation blanket assembly of claim 7, wherein said sheet material is connected to said mounting strips.

9. The heat insulation blanket assembly of claim 1, wherein said sheet material is loosely maintained at said second surface of said blanket and is suspended away from said blanket when supported by said Kraft paper in a position below said blanket.

10. A heat insulation blanket assembly for retarding the transfer of heat between adjacent spaces, comprising:
an elongated blanket of heat insulation material having a fibrous surface, flexible sheet material extending along said elongated blanket superposed said fibrous surface,
said flexible sheet bearing a heat reflective surface facing said fibrous surface of said blanket,
said fibrous surface having surface fibers in engagement with said heat reflective surface of said flexible sheet with air gaps formed about said surface fibers and adjacent said reflective surface,
whereby said air gaps maintain the reflective properties of said heat reflective surface of said flexible sheet material.

11. The heat insulation blanket assembly of claim 10, wherein said blanket is formed of material selected from a group consisting of fiberglass, mineral wool and cellulose.

12. The heat insulation blanket assembly of claim 10, wherein said sheet material is selected from the group consisting of: polyester having a metalized surface, polyethylene with a metalized surface, and aluminum.

13. The heat insulation blanket assembly of claim 10, wherein said air gaps between said surface fibers engage more area of said sheet material than said surface fibers.

14. The heat insulation blanket assembly of claim 10, wherein said sheet material has a series of spaced air openings formed therein for the passage of air into and out of said blanket.

15. The heat insulation blanket assembly of claim 10, and further including a layer of Kraft paper extending on one side of said blanket and with said flexible sheet material extending on the other side of said blanket, and with said Kraft paper and flexible sheet material connected to each other for completely surrounding the cross section of said blanket.

16. The heat insulation blanket assembly of claim 10, wherein said flexible sheet material is loosely maintained in superposed relationship with respect to said blanket and is suspended away from said blanket when positioned below said blanket.

17. The heat insulation blanket assembly of claim 10, wherein said flexible sheet material comprises foil.

18. A method of insulating a building structure for retarding heat transfer between spaces in and about the building structure, comprising:
providing a blanket of heat insulation with a fibrous surface,
providing a flexible sheet material having a heat reflective surface,
placing the heat reflective surface of the flexible sheet in superposed relationship with the fibrous surface of the blanket,
supporting the flexible sheet material with the fibers of the fibrous surface of the blanket,
maintaining the reflectivity of the heat reflective surface of the flexible sheet with air spaces between the fibers of the fibrous surface that support the flexible sheet.

19. The method of insulating a building structure of claim 18, and further including the step of:
placing a sheet of Kraft paper on one side of the blanket, and
extending the flexible sheet about the opposite side of the blanket and attaching the flexible sheet to the Kraft paper to surround the blanket.
